(19) United States
(12) Patent Application Publication
(10) Pub. No.: US 2009/0086256 A1
(43) Pub. Date: Apr. 2, 2009

(54) CONDITIONAL CONTENT PRINTING

(75) Inventors: Javier A. Morales, Irondequoit, NY (US); Michael E. Farrell, Webster, NY (US)

Correspondence Address: PEPPER HAMILTON LLP, 500 GRANT STREET, ONE MELLON CENTER, 50TH FLOOR, PITTSBURGH, PA, 15219, US

(73) Assignee: XEROX CORPORATION, Stamford, CT (US)

(21) Appl. No.: 11/866,084

(22) Filed: Oct. 2, 2007

(51) Int. Cl. G06F 3/12

(52) U.S. Cl. 358/1.15

(57) ABSTRACT

A method of conditional content printing may include receiving a job, wherein the job includes a base layer and a first conditional content layer. One or more printing parameters may be received. The job may be automatically processed by a resource based on the one or more printing parameters to produce a first document and a second document. Both the first document and the second document may include the base layer. The first document may include the conditional content layer. The second document may not include the conditional content layer. A sheet may be printed for the first and the second document. The sheet for the first document may include the base layer and the first conditional content layer. The sheet for the second document may include the base layer.

### BACKGROUND

A document publisher can create different versions of a document. For example, there might be different versions of a newspaper, a magazine, a book, a journal, or a treatise. While each version of a document could contain different content, such as pictures or text, the format of the document often remains the same. For example, the cover of a magazine would have a different picture and headlines each month, but the placement of the picture and headlines could remain constant.

Typically, in a printing environment, each version of the document is printed as a separate print job. U.S. Pat. No. 7,233,409 describes a method and system for printing a single job. The single job contains separate layers of content such as base content and conditional content. Conditional content is the content that changes in each version of the document. Base content is the content or format that remains constant in multiple versions of the document.

For example, a first job could have a September version of a magazine that includes a base layer and a first conditional content layer. A second job could have an October version of the magazine that includes the same base layer and a second conditional content layer. Because each version of the document is contained in a different job, the September issue is processed in one print job, while the October issue is processed in a different print job.

A print job containing one or more conditional content layers is more complex than a standard print job because each conditional content layer must be managed to ensure the layer processing is synchronized. Currently, processing multiple jobs with conditional content layers requires manually processing each layer.

### SUMMARY

In an embodiment, a computer-implemented method of conditional content printing may include receiving a job, wherein the job may include a base layer and a conditional content layer. One or more printing parameters may be received. A resource may automatically process the job based on the one or more printing parameters to produce a first document and a second document. Both the first document and the second document may include the base layer. The first document may include the conditional content layer and the second document may not include the conditional content layer. A sheet may be printed for the first document and the second document. The sheet for the first document may include the base layer and the conditional content layer. The sheet for the second document may include the base layer without the conditional content layer.

In an embodiment, a promotional layer may be received which may include one or more of the following: an order number, a name of a print shop, contact information for a customer sales representative, a time to complete an order and any promotional discounts, In an embodiment, the conditional content layer may be distinguished from the base layer by a page description language (PDL) layer identifier. In an alternate embodiment, the conditional content layer may be distinguished from the base layer by a flag via one or more layer property selections.

In an embodiment, receiving one or more printing parameters may include receiving a first printing parameter for the base layer and receiving a second printing parameter for the conditional content layer. In an embodiment, receiving one or more printing parameters may include receiving one or more of the following: a number of documents to produce, a number of times a layer is printed, an order in which to print a layer and content for a layer.

In an embodiment, a system for conditional content printing may include a computing device and a resource. The computing device may be configured to receive a job and receive one or more printing parameters. The job may include a base layer and a conditional content layer. The resource may be configured to automatically process the job based on the one or more printing parameters to produce a first document and a second document. Both the first document and the second document may include the base layer. The first document may include the conditional content layer. The second document may not include the conditional content layer. The resource may be further configured to print a sheet for the first document and the second document. The sheet for the first document may include the base layer and the first conditional content layer, and the sheet for the second document may include the base layer.

In an embodiment, the computing device may be further configured to receive a promotional layer which may include one or more of the following: an order number, a name of a print shop, contact information for a customer sales representative, a time to complete an order and any promotional discounts. In an embodiment, the computing device may be further configured to print the base layer and the conditional content layer on the first document and print the base layer on the second document. In an embodiment, the computing device may be further configured to distinguish the conditional content layer from the base layer by a page description language (PDL) layer identifier. In an alternate embodiment, the computing device may be further configured to distinguish the conditional content layer from the base layer by a flag via one or more layer property selections.

In an embodiment, a method of conditional content printing may include receiving a job, wherein the job may include a base layer, a first conditional content layer, and a second conditional content layer. One or more printing parameters may be received. A resource may automatically process the job based on the one or more printing parameters to produce a first document and a second document. Both the first document and the second document may include the base layer. The first document may include the first conditional content layer and the second document may not include the first conditional content layer. A sheet may be printed for the first document and the second document. The sheet for the first document may include the base layer and the first conditional content layer, and the sheet for the second document may include the base layer and the second conditional content layer.

### BRIEF DESCRIPTION OF THE DRAWINGS

Aspects, features, benefits and advantages of the embodiments described herein will be apparent with regard to the following description, appended claims, and accompanying drawings where:

FIG. 1 illustrates an exemplary conditional content printing system according to an embodiment.

FIG. 2 depicts a flowchart of an exemplary method of conditionally printing content according to an embodiment.

FIGS. 3A-D depict exemplary jobs having multiple conditional content layers according to embodiments.

### DETAILED DESCRIPTION

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

As used herein and in the appended claims, the singular forms “a,” “an,” and “the” include the plural reference unless the context clearly dictates otherwise. Thus, for example, reference to a “document” is a reference to one or more documents and equivalents thereof known to those skilled in the art, and so forth. Unless defined otherwise, all technical and scientific terms used herein have the same meanings as commonly understood by one of ordinary skill in the art. As used herein, the term “comprising” means “including, but not limited to.”

A resource is a device that generates an electronic document either by itself or in coordination with other resources. A resource may include, but is not limited to, a printing device, a multifunction device, a router, a web server and/or other devices. A printing device is an electronic device that is capable of receiving commands, printing text and/or images on a substrate and/or scanning a document. Printing devices may include, but are not limited to, network printers, production printers, copiers, faxes, other devices using ink or toner, or scanners. As used herein, the words ink and toner are used interchangeably to refer to wet or dry material that forms an image or text on a substrate. Printing devices may also contain a combination of functions such as printing/scanning/faxing, in which case such devices may be considered to be multifunctional devices.

A resource generates an electronic document by performing one or more jobs. The term “job,” as used herein, refers to the instructions and parameters pursuant to which an item is processed using one or more resources. In a document processing environment, a “job” refers to one or more documents to be scanned or processed and one or more instructions used to process the documents. Exemplary instructions may include, but are not limited to, instructions for scanning, printing, faxing, binding and/or stapling one or more documents.

A job may contain one or more layers. A layer is a set or grouping of content. A parameter is a criterion for determining how a job is processed. A printing parameter is a criterion for determining how a job is printed. A printing parameter may include, but is not limited to, a number of documents to produce, a number of times a layer is printed, an order in which to print a layer, and content for a layer.

An electronic document includes an electronic representation of one or more sheets. A sheet is a single printed medium. A sheet may include, but is not limited to, a page or a poster. Each sheet may include a base layer and one or more conditional content layers.

A base layer contains information that is processed and printed for all documents in a job. A conditional content layer is a layer containing information that may be processed and printed resulting in additional content on a sheet in a document. Conditional content may be processed and printed on less than all of the documents in a job. Conditional content may be used to alternate content on a single sheet within a document. Conditional content may include, but is not limited to, a watermark, a picture, text, and/or an image.

In one embodiment, a sheet may be printed for a first and second document. The first document may be a first version, edition or publication, while the second document may be a subsequent version, edition or publication. The sheet for the first document may include a base layer and a first conditional content layer. The sheet for a second document may include the base layer and a second conditional content layer.

A digital front end (DFE) is a device that combines one or more functions provided at output. A DFE application processes the document to prepare it for printing. The DFE may include one or more features such as, but not limited to, data compression, image compression, color conversion, cluster printing, parallel processing and job ticketing.

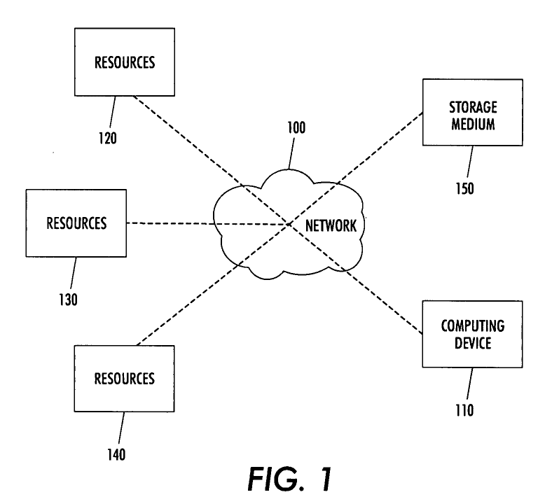

FIG. 1 illustrates an exemplary conditional content printing system according to an embodiment. As shown in FIG. 1, the system may include a computing device 110, one or more resources 120, 130, 140, a storage medium 150, and a network 100.

A computing device 110 processes data to perform one or more functions. The computing device 110 may be any processor-based device such as, for example, a server, a personal computer, a personal digital assistant, a web-enabled phone, a smart terminal and/or a dumb terminal. A computing device 110 may also include, but is not limited to, a computer, a cell phone, a personal digital assistant and/or other electronic device capable of communicating in a networked environment.

The system may include a plurality of resources 120, 130, 140. A resource 120, 130, 140 may access a storage medium 150. Alternatively, the storage medium 150 may be contained within one or more of the resources 120, 130, 140. The storage medium 150 may be any repository of searchable data, such as, but not limited to, a database, a computer-readable memory, a table or other medium. The storage medium 150 may communicate with the computing device 110 and the one or more resources 120, 130, 140 via a network 100 such as a local area network (LAN), a wide area network (WAN), the Internet, a universal serial bus (USB) network, a Bluetooth network and/or any other communications network. In an embodiment, the storage medium 150 may be distributed across a plurality of devices including, but not limited to, the computing device 110 and/or the one or more resources 120, 130, 140. If the storage medium 150, or a portion thereof is contained within the computing device 110 or the one or more resources 120, 130, 140 the storage medium may directly communicate with the computing device or the resource instead of via the network 100.

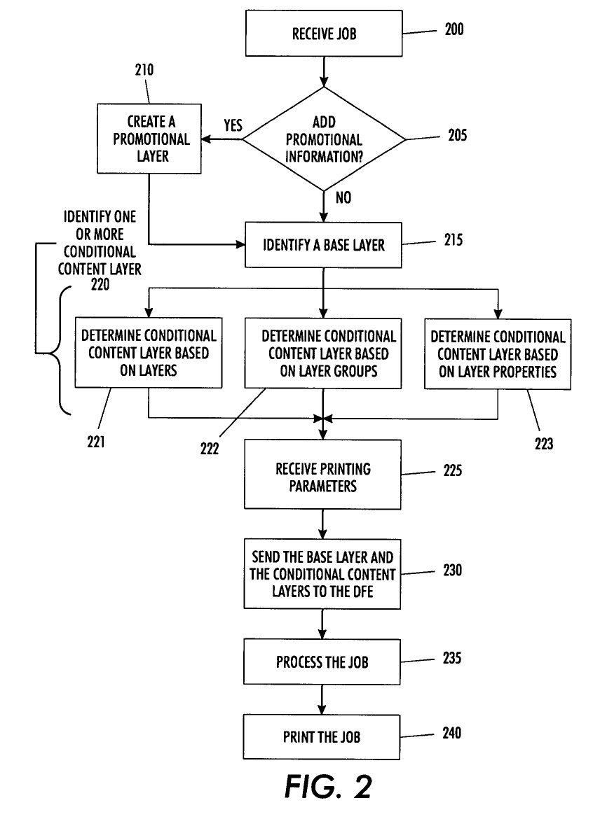

FIG. 2 depicts a flowchart of an exemplary method of conditionally printing content according to an embodiment. First, a job may be received by a computing device from another device or a user 200. In an alternate embodiment, the job may be stored or generated by a computing device.

A user may decide to add promotional information 205. Promotional information is business-related data and/or background information about the job. The promotional information may include, but is not limited to, an order number, a name of a print shop, contact information for a customer sales representative, a time the order must be completed and/or any promotional discounts. If promotional information is added, a promotional layer may be created 210. In an embodiment, the promotional layer may not be printed. In an alternate embodiment, the promotional layer may be printed.

The job may be examined to identify a base layer 215 and one or more conditional content layers 220. In an embodiment, the base layer may be identified by a predefined page description language (PDL) layer. In an embodiment, a document may include only two layers 221. However, jobs having more than two layers are also included in the embodiments described herein. A first layer may include conditional content while a second layer may include base content. Alternatively, a user may organize the document into two layer groups 222. One layer group may be treated as a base layer group. The second layer group may be treated as a conditional content layer group. A layer group may contain one or more layers. For example, a job may have a first layer group with one base layer and a second layer group with three conditional content layers.

In an alternate embodiment, a conditional content layer may be determined based on predetermined or preselected layer properties 223. In one embodiment, the properties of the layer may be determined based on flags inserted during document creation. In an alternate embodiment, the properties of the layer may be signaled using flags during print processing. In one embodiment, if the signaling occurs during print processing, no support may be needed from the authoring application.

One or more printing parameters for the job may be received 225. A printing parameter may be received by the system from a user or a storage device. Alternatively, a printing parameter may be generated by a computing device. In an embodiment, printing parameters may be received for both the base layer and the one or more conditional content layers of a job. For example, if the conditional content layer contains a print process control target based on the contents of the job, printing parameters may specify a print frequency and an alternate sheet delivery destination. In an embodiment, a printing parameter may include an instruction to combine content layers based on text encoding.

In an embodiment, a printing parameter may specify what conditional content layers are printed. The conditional content layers may be organized in a multilayered order. The printing parameter may specify one or more layers to be included for a particular print job. For example, if a sports magazine has a national circulation, pictures of different basketball teams may be printed on the front cover of the magazine based on the region of the country to which a particular copy will be sent.

In one embodiment, the base layer and the one or more conditional content layers may be sent to a digital front end (DFE) for processing 230. The DFE may receive the base layer and the one or more conditional content layers based on the one or more printing parameters. Alternatively, the base layer and the one or more conditional content layers may already be located at the DFE and ready to be processed. The job may then be processed 235. The DFL may include separate raster image processing (RIP) for the base layer and the conditional content layer. The conditional content layer may overlay the base layer using the one or more printing parameters.

In one embodiment, processing the job may include printing 240. For example, a printing parameter may specify that the print frequency is five for the base layer, three for a first conditional layer and two for a second conditional layer. The DFE may print the base layer five times and then produce three copies with the first conditional content layer and two copies with the second conditional content layer. In an alternate embodiment, a print job may produce a base layer with more than one conditional content layer. In an embodiment, a base layer with a particular conditional content layer may be reordered without sending an entirely new job.

In an embodiment, the cost of the job may be based on the base layer and the various layers of the conditional content. For example, a print shop may charge a certain amount for each conditional content layer printed. The base layer may cost $0.50 per copy while the first conditional content layer may cost $0.25 per copy and the second conditional content layer may cost $0.10 per copy.

For example, a job may be received to print a sheet of a newspaper 200. Promotional information may he included 205 in a promotional layer 210. A base layer may be identified 215 which has the title of the newspaper and text of a story about the President. Multiple conditional content layers may be identified. A first conditional content layer may include text of a story about a drought, a second conditional content layer may include text of a story about a fire, a third conditional content layer may include standard headlines and a fourth conditional content layer may include more dramatic headlines 220. Printing parameters may be received 225. A first printing parameter may specify a region of the country. In an embodiment, the region may be specified by zip code. A second printing parameter may specify whether the sheet of the newspaper is for a subscriber. The base layer along with the conditional content layers may be sent to the DFE 230. The job may be processed 235 and printed 240. Based on the region, the sheet of the newspaper may include text about the drought. The sheet for a different region may include text about the fire instead of the text about the drought. Additionally, the sheet of the newspaper sent to a subscriber in the region with the drought may have a different headline than the sheet of a non-subscriber in the same region. For example, the non-subscriber's newspaper may be sent to newsstands, and the headlines may be more dramatic in order to capture a reader's attention. However, all the newspapers may have the same base layer containing the title of the newspaper and a story about the President on the sheet.

### EXAMPLE

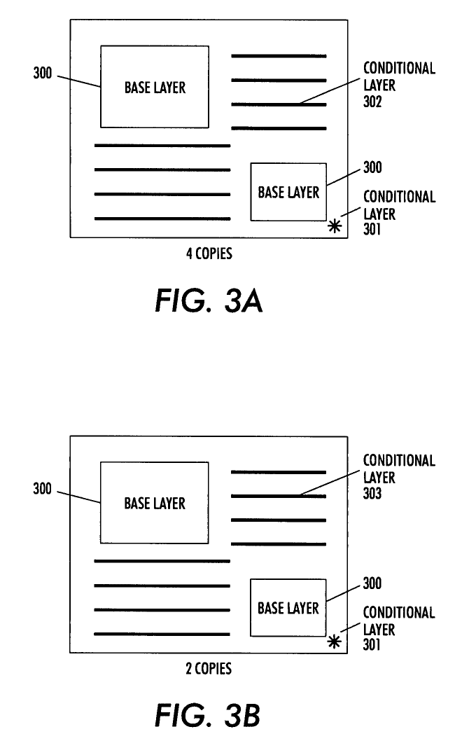

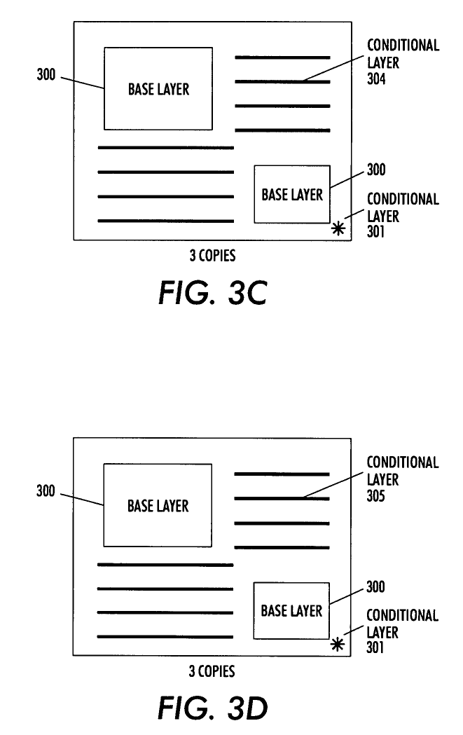

FIGS. 3A-D depict a single job with multiple conditional content layers in four embodiments. FIGS. 3A-D depict printed content from one print job. For example, processing and printing the print job may create a magazine page. The magazine page may include two pictures, a logo, and an article. The article may be written in a variety of languages. The job may include a base layer 300. A printing parameter may specify that the base layer 300 be printed ten times. The job may also include a first conditional content layer. The printing parameter associated with the first conditional content layer may depict a logo to he placed on the bottom right portion of the page. The printing parameter may specify that the first conditional content layer be printed on nine copies. The printing parameter may be used to identify the versions of the document that will contain each of the conditional content layers.

In the example depicted below, five conditional layers may be included in a single print job. A version may include one or more of the conditional content layers. The printing parameters may be used to specify the conditional layers that will be included in a particular version.

FIG. 3A is an exemplary embodiment of the print job. As shown in FIG. 3A, the magazine page may depict a second conditional content layer 302 along with the base layer 300 and the first conditional content layer 301. The second conditional layer 302 may include an article written in English. A printing parameter may be associated with the second conditional content layer 302. The printing parameter may state that the second conditional layer 302 may be printed four times. In other words, four copies of the magazine may be produced in English.

FIG. 3B depicts an embodiment of the magazine page including the same base layer, the first conditional content layer and a third conditional content layer. The third conditional content layer 303 may include the article written in French. The printing parameter associated with the third conditional content layer 303 may be two. As such, two copies of the magazine may be produced in French.

FIG. 3C also may show an embodiment of the magazine page with the same base layer, the first conditional content layer, and a fourth conditional content layer. The fourth conditional content layer 304 may include the article written in Spanish. The printing parameter associated with the fourth conditional content layer 304 may he three. As such, three copies of the magazine may be produced in Spanish.

Lastly, FIG. 3D may depict an embodiment of the magazine page with the same base layer, the first conditional content layer, and a fifth conditional content layer. The fifth conditional content layer 305 may include the article written in German. The printing parameter associated with the fifth conditional content layer 305 may be one. As such, one copy of the magazine may be produced in German.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A computer-implemented method of conditional content printing comprising:
receiving a job, wherein the job comprises a base layer and a conditional content layer;
receiving one or more printing parameters;
automatically processing the job, by a resource, based on the one or more printing parameters to produce a first document and a second document, wherein both the first document and the second document comprise the base layer, the first document comprises the conditional content layer, and the second document does not comprise the conditional content layer; and
printing a sheet for the first document and the second document, wherein the sheet for the first document comprises the base layer and the conditional content layer, and the sheet for the second document comprises the base layer without the conditional content layer.

2. The method of claim 1, further comprising:
receiving a promotional layer comprising one or more of the following: an order number, a name of a print shop, contact information for a customer sales representative, a time to complete an order, and any promotional discounts.

3. The method of claim 1, further comprising:
distinguishing the conditional content layer from the base layer by a page description language (PDL) layer identifier.

4. The method of claim 1, further comprising:
distinguishing the conditional content layer from the base layer by a flag via one or more layer property selections.

5. The method of claim 1 wherein receiving one or more printing parameters comprises:
receiving a first printing parameter for the base layer; and
receiving a second printing parameter for the conditional content layer.

6. The method of claim 1 wherein receiving one or more printing parameters comprises receiving one or more of the following:
a number of documents to produce, a number of times a layer is printed, an order in which to print a layer, and content for a layer.

7. A system for conditional content printing comprising:
a computing device configured to:
receive a job, wherein the job comprises a base layer and a conditional content layer, and
receive one or more printing parameters; and
a resource configured to automatically process the job based on the one or more printing parameters to produce a first document and a second document, wherein both the first document and the second document comprise the base layer, the first document comprises the conditional content layer, and the second document does not comprise the conditional content layer, and wherein the resource is further configured to print a sheet for the first document and the second document, wherein the sheet for the first document comprises the base layer and the first conditional content layer, and the sheet for the second document comprises the base layer.

8. The system of claim 7 wherein the computing device is further configured to receive a promotional layer comprising one or more of the following: an order number, a name of a print shop, contact information for a customer sales representative, a time to complete an order, and any promotional discounts.

9. The system of claim 7 wherein the computing device is further configured to:
print the base layer and the conditional content layer on the first document; and
print the base layer on the second document.

10. The system of claim 7 wherein the computing device is further configured to:
distinguish the conditional content layer from the base layer by a page description language (PDL) layer identifier.

11. The system of claim 7 wherein the computing device is further configured to:
distinguish the conditional content layer from the base layer by a flag via one or more layer property selections.

12. A method of conditional content printing comprising:
receiving a job, wherein the job comprises a base layer, a first conditional content layer, and a second conditional content layer;
receiving one or more printing parameters;
automatically processing the job, by a resource, based on the one or more printing parameters to produce a first document and a second document, wherein both the first document and the second document comprise the base layer, the first document comprises the first conditional content layer and the second document does not comprise the first conditional content layer; and
printing a sheet for the first document and the second document, wherein the sheet for the first document comprises the base layer, and the first conditional content layer, and the sheet for the second document comprises the base layer and the second conditional content layer.

13. The method of claim 12, further comprising:
distinguishing the first conditional content layer from the second conditional content layer by a page description language (PDL) layer identifier.

14. The system of claim 12, further comprising:
distinguishing the first conditional content layer from the second conditional content layer by a flag via one or more layer property selections.

15. The method of claim 12, further comprising:
receiving a promotional layer comprising one or more of the following: an order number, a name of a print shop, contact information for a customer sales representative, a time to complete an order, and any promotional discounts,

16. The method of claim 12 wherein receiving one or more printing parameters comprises receiving one or more of the following:
a number of documents to produce, a number of times a layer is printed, an order in which to print a layer, and content for a layer.
